(19) United States
(12) Patent Application Publication
(10) Pub. No.: US 2014/0375755 A1
(43) Pub. Date: Dec. 25, 2014

(54) APPARATUS AND METHOD FOR CHANGING MAIN SCREEN BASED ON DISTRIBUTED TELEPRESENCE

(71) Applicant: ELECTRONICS AND TELECOMMUNICATIONS RESEARCH INSTITUTE, DAEJEON-CITY (KR)

(72) Inventors: Seung-Han CHOI, Daejeon (KR); Do-Young KIM, Daejeon (KR)

(73) Assignee: ELECTRONICS AND TELECOMMUNICATIONS RESEARCH INSTITUTE, DAEJEON-CITY (KR)

(21) Appl. No.: 14/087,248

(22) Filed: Nov. 22, 2013

(30) Foreign Application Priority Data
Jun. 24, 2013 (KR) 10-2013-0072736
Oct. 30, 2013 (KR) 10-2013-0129943

(51) Int. Cl. H04N 7/15

(52) U.S. Cl. CPC H04N 7/152
USPC 348/14.09

(57) ABSTRACT

Disclosed herein are an apparatus and method for changing a main screen based on distributed telepresence. A distributed telepresence-based control server includes a main speaker change request reception unit for receiving a main speaker change request for requesting change of a main speaker from a first speaker who is an existing main speaker to a second speaker different from the first speaker. A video transmission requesting unit requests a client of the second speaker to transmit a high-resolution video of the second speaker in response to the main speaker change request. A video transmission stop request reception unit receives a video transmission stop request for requesting stop of transmission of a high-resolution video of the first speaker. A video transmission stop requesting unit requests a client of the first speaker to stop transmitting the high-resolution video of the first speaker in response to the video transmission stop request.

### CROSS REFERENCE TO RELATED APPLICATIONS

This application claims the benefit of Korean Patent Application Nos. 10-2013-0072736 filed on Jun. 24, 2013 and 10-2013-0129943 filed on Oct. 30, 2013, which are hereby incorporated by reference in their entirety into this application.

### BACKGROUND OF THE INVENTION

1. Technical Field

The present invention relates generally to an apparatus and method for changing a main screen based on distributed telepresence and, more particularly, to a an apparatus and method for changing a main screen based on a distributed telepresence, which enable high-resolution videos of main speakers to be naturally replaced without being interrupted when a user client changes a main speaker.

2. Description of the Related Art

Recently, there is a growing trend which emphasizes a work and life balance in work conditions, and thus interest in telepresence markets together with smart work has increased. Telepresence is a service for providing an experience allowing a user to feel as if another party were actually present in front of the user.

Generally, a telepresence system transmits a high-resolution video of only a main speaker so as to prevent a load on the Internet from increasing when high-resolution videos of all speakers are transmitted.

In a telepresence system, the provision of a seamless and natural screen without interruption is a very important factor for being immersed in conversation or in providing reliability to the other party. However, as described above, in the generally used telepresence system, a high-resolution video of only a main speaker is transmitted, and thus there is a problem in that when a main speaker is changed, a screen is interrupted, and an unnatural experience is provided to the user.

Korean Patent Application Publication No. 2012-0047512 relates to a video call apparatus for group media communication and a method of processing the video call, and discloses technology for compressing and transmitting video data for a multiparty video call.

However, such conventional telepresence system technology includes technologies for simply compressing and transmitting videos of all screens, and does not describe a scheme for transmitting a high-resolution video for a main screen.

Therefore, there is a requirement for new technology which can naturally replace high-resolution videos of main speakers without being interrupted, by displaying a high-resolution video of an existing main speaker on a screen until a high-resolution video of a new main speaker is received so as to provide a seamless telepresence system, thus providing a more natural telepresence system.

### SUMMARY OF THE INVENTION

Accordingly, the present invention has been made keeping in mind the above problems occurring in the prior art, and an object of the present invention is to provide a more natural telepresence system, which can naturally replace high-resolution videos of main speakers without being interrupted by displaying a high-resolution video of an existing main speaker on a screen until a high-resolution video of a new main speaker is received when a user client changes a main speaker.

Another object of the present invention is to provide a more efficient telepresence system, which can receive a high-resolution video of a new main speaker from a media processing device without repeatedly making a request to transmit the high-resolution video while the high-resolution video of the new main speaker is requested and is currently being received by another user client.

In accordance with an aspect of the present invention to accomplish the above objects, there is provided a distributed telepresence-based control server, including a main speaker change request reception unit for receiving a main speaker change request for requesting a change of a main speaker from a first speaker who is an existing main speaker to a second speaker who is different from the first speaker; a video transmission requesting unit for requesting a client of the second speaker to transmit a high-resolution video of the second speaker in response to the main speaker change request; a video transmission stop request reception unit for receiving a video transmission stop request for requesting stop of transmission of a high-resolution video of the first speaker; and a video transmission stop requesting unit for requesting a client of the first speaker to stop transmitting the high-resolution video of the first speaker in response to the video transmission stop request.

Preferably, the video transmission requesting unit may be configured to determine whether the client of the second speaker is transmitting the high-resolution video of the second speaker, and if it is determined that the client of the second speaker is not transmitting the high-resolution video of the second speaker, request the client of the second speaker to transmit the high-resolution video of the second speaker.

Preferably, the video transmission requesting unit may request the client of the second speaker to insert an identifier for packet switching into the high-resolution video of the second speaker and transmit a resulting high-resolution video of the second speaker.

Preferably, the video transmission requesting unit may request a media processing device to generate an identifier-based switching entry of the second speaker, and request the client of the second speaker to transmit the high-resolution video of the second speaker to the media processing device.

Preferably, the media processing device may retransmit the high-resolution video of the second speaker to a user client according to the identifier-based switching entry.

Preferably, the video transmission stop requesting unit may be configured to determine whether the client of the first speaker is transmitting the high-resolution video of the first speaker to another user client different from the user client, and if it is determined that the client of the first speaker is not transmitting the high-resolution video of the first speaker to another user client different from the user client, request the client of the first speaker to stop transmitting the high-resolution video of the first speaker.

Preferably, the video transmission stop requesting unit may request the media processing device to delete an identifier-based switching entry of the first speaker.

Preferably, the media processing device may receive a video of at least one client, and retransmits the video to one or more of at least one client different from the client and at least one media processing device different from the media processing device.

In accordance with another aspect of the present invention to accomplish the above objects, there is provided a distributed telepresence-based user client, including a main speaker change requesting unit for transmitting a main speaker change request so that a main speaker is changed from a first speaker who is an existing main speaker to a second speaker who is different from the first speaker; a video replacement unit for naturally replacing a high-resolution video of the first speaker with a high-resolution video of the second speaker received in response to the main speaker change request and displaying the high-resolution video of the second speaker to a user; and a video transmission stop requesting unit for transmitting a video transmission stop request so that transmission of the high-resolution video of the first speaker is stopped.

Preferably, the main speaker may be determined in consideration of one or more of results of analysis of audio signals of speakers and the user's selective input for low-resolution videos of the speakers.

In accordance with a further aspect of the present invention to accomplish the above objects, there is provided a method of changing a main screen based on distributed telepresence, including requesting a client of a second speaker to transmit a high-resolution video of the second speaker so that a main speaker is changed from a first speaker who is an existing main speaker to the second speaker who is different from the first speaker; naturally replacing a high-resolution video of the first speaker with the high-resolution video of the second speaker and displaying the high-resolution video of the second speaker to a user; and requesting a client of the first speaker to stop transmitting the high-resolution video of the first speaker so that transmission of the high-resolution video of the first speaker is stopped.

Preferably, requesting the client of the second speaker may be configured to determine whether the client of the second speaker is transmitting the high-resolution video of the second speaker, and if it is determined that the client of the second speaker is not transmitting the high-resolution video of the second speaker, request the client of the second speaker to transmit the high-resolution video of the second speaker.

Preferably, requesting the client of the second speaker may be configured to request the client of the second speaker to insert an identifier for packet switching into the high-resolution video of the second speaker and transmit a resulting high-resolution video of the second speaker.

Preferably, requesting the client of the second speaker may be configured to request a media processing device to generate an identifier-based switching entry of the second speaker, and request the client of the second speaker to transmit the high-resolution video of the second speaker to the media processing device.

Preferably, the media processing device may retransmit the high-resolution video of the second speaker to a user client according to the identifier-based switching entry.

Preferably, requesting the client of the first speaker may be configured to determine whether the client of the first speaker is transmitting the high-resolution video of the first speaker to another user client different from the user client, and if it is determined that the client of the first speaker is not transmitting the high-resolution video of the first speaker to another user client different from the user client, request the client of the first speaker to stop transmitting the high-resolution video of the first speaker.

Preferably, requesting the client of the first speaker may be configured to request the media processing device to delete an identifier-based switching entry of the first speaker.

Preferably, the media processing device may receive a video of at least one client, and retransmit the video to one or more of at least one client different from the client and at least one media processing device different from the media processing device.

Preferably, the main speaker may be determined in consideration of one or more of results of analysis of audio signals of speakers and the user's selective input for low-resolution videos of the speakers.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a distributed telepresence-based control server according to an embodiment of the present invention;

FIG. 2 is a block diagram showing a distributed telepresence-based media processing device according to an embodiment of the present invention;

FIG. 3 is a block diagram showing a distributed telepresence-based user client according to an embodiment of the present invention;

FIG. 4 is an operation flowchart showing a method of changing a main screen based on distributed telepresence according to an embodiment of the present invention;

FIG. 5 is an overall operation flowchart showing the method of changing the main screen based on distributed telepresence according to the present invention;

FIG. 6 is an operation flowchart showing the method of changing the main screen based on distributed telepresence according to the present invention from the standpoint of a media processing device;

FIG. 7 is an operation flowchart showing the method of changing the main screen based on distributed telepresence according to the present invention from the standpoint of a control server;

FIG. 8 is a diagram showing an embodiment of a system for changing a main screen based on distributed telepresence according to the present invention;

FIG. 9 is a diagram showing another embodiment of the system for changing the main screen based on distributed telepresence according to the present invention;

FIG. 10 is a diagram showing a further embodiment of the system for changing the main screen based on distributed telepresence according to the present invention;

FIG. 11 is a diagram showing yet another embodiment of the system for changing the main screen based on distributed telepresence according to the present invention; and

FIG. 12 is a diagram showing still another embodiment of the system for changing the main screen based on distributed telepresence according to the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, preferred embodiments of the present invention will be described in detail with reference to the attached drawings.

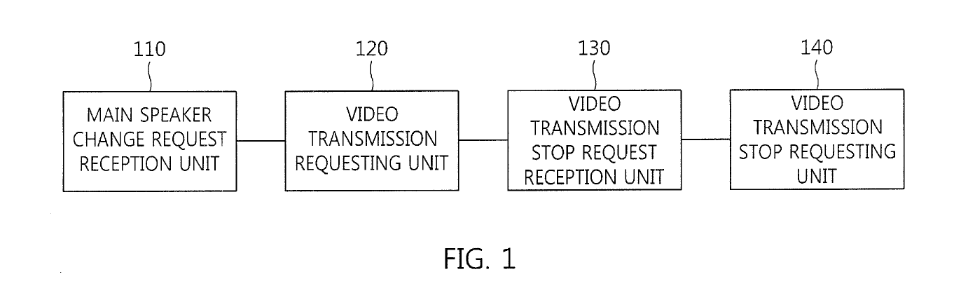

FIG. 1 is a block diagram showing a distributed telepresence-based control server according to an embodiment of the present invention.

Referring to FIG. 1, the distributed telepresence-based control server according to the embodiment of the present invention includes a main speaker change request reception unit 110, a video transmission requesting unit 120, a video transmission stop request reception unit 130, and a video transmission stop requesting unit 140.

The main speaker change request reception unit 110 receives a main speaker change request for requesting the change of a main speaker from a first speaker who is an existing main speaker to a second speaker who is different from the first speaker.

In this case, the main speaker may be determined in consideration of one or more of the results of analysis of audio signals of speakers and a user's selective input for low-resolution videos of the speakers.

The video transmission requesting unit 120 requests the client of the second speaker to transmit a high-resolution video of the second speaker in response to the main speaker change request.

In this case, the video transmission requesting unit 120 determines whether the client of the second speaker is transmitting the high-resolution video of the second speaker, and if it is determined that the client of the second speaker is not transmitting the high-resolution video of the second speaker, may request the client of the second speaker to transmit the high-resolution video of the second speaker.

In this regard, the video transmission requesting unit 120 may request the client of the second speaker to insert an identifier for packet switching into the high-resolution video of the second speaker and to transmit a resulting high-resolution video of the second speaker.

Further, the video transmission requesting unit 120 may request a media processing device to generate the identifier-based switching entry of the second speaker and may request the client of the second speaker to transmit the high-resolution video of the second speaker to the media processing device.

In this case, the media processing device may retransmit the high-resolution video of the second speaker to a user client according to the identifier-based switching entry.

The video transmission stop request reception unit 130 receives a video transmission stop request for requesting the stop of the transmission of the high-resolution video of the first speaker.

The video transmission stop requesting unit 140 requests the client of the first speaker to stop transmitting the high-resolution video of the first speaker in response to the video transmission stop request.

In this case, the video transmission stop requesting unit 140 determines whether the client of the first speaker is transmitting the high-resolution video of the first speaker to another user client different from the user client, and if it is determined that the client of the first speaker is not transmitting the high-resolution video of the first speaker to another user client different from the user client, may request the client of the first speaker to stop transmitting the high-resolution video of the first speaker.

In this case, the video transmission stop requesting unit 140 may request the media processing device to delete the identifier-based switching entry of the first speaker.

The media processing device may receive a video of at least one client and may retransmit the video to one or more of at least one client different from the corresponding client and at least one media processing device different from the corresponding media processing device.

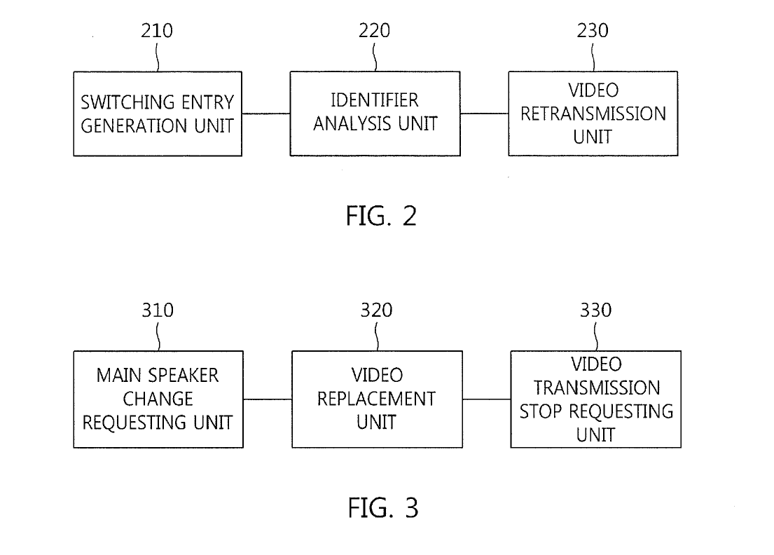

FIG. 2 is a block diagram showing a distributed telepresence—based media processing device according to an embodiment of the present invention.

Referring to FIG. 2, the distributed telepresence-based media processing device according to the embodiment of the present invention includes a switching entry generation unit 210, an identifier analysis unit 220, and a video retransmission unit 230.

The switching entry generation unit 210 generates an identifier-based switching entry in response to an identifier-based switching entry generation request received from a control server.

For example, the switching entry generation unit 210 is configured to, when a request to generate the identifier-based switching entry of the second speaker is received from the control server, generate the identifier-based switching entry of the second speaker in response to the request.

The identifier analysis unit 220 receives the high-resolution video from the client, and analyzes an identifier inserted into the packet of the high-resolution video.

For example, the identifier analysis unit 220 receives a high-resolution video of a second speaker generated by inserting the identifier of the second speaker into the high-resolution video from the client of the second speaker, and analyzes the identifier of the second speaker inserted into the packet of the high-resolution video of the second speaker.

The video retransmission unit 230 retransmits the high-resolution video according to the switching entry using the identifier inserted into the packet of the high-resolution video.

For example, the video retransmission unit 230 retransmits the high-resolution video of the second speaker to one of the corresponding user client and the media processing device of the user client according to the identifier-based switching entry of the second speaker using the identifier inserted into the packet of the high-resolution video of the second speaker.

Although not shown in FIG. 2, the distributed telepresence-based media processing device according to the embodiment of the present invention may further include a switching entry deletion unit for deleting the identifier-based switching entry of the first speaker in response to the first speaker's identifier-based switching entry deletion request received from the control server.

FIG. 3 is a block diagram showing a distributed telepresence-based user client according to an embodiment of the present invention.

Referring to FIG. 3, the distributed telepresence-based user client according to the embodiment of the present invention includes a main speaker change requesting unit 310, a video replacement unit 320, and a video transmission stop requesting unit 330.

The main speaker change requesting unit 310 transmits a main speaker change request so that a main speaker is changed from a first speaker who is an existing main speaker to a second speaker who is different from the first speaker.

In this case, the main speaker may be determined in consideration of one or more of the results of analysis of audio signals of speakers and a user's selective input for low-resolution videos of the speakers.

The video replacement unit 320 may naturally replace a high-resolution video of the first speaker with a high-resolution video of the second speaker received in response to the main speaker change request, and display the high-resolution video of the second speaker to the user.

The video transmission stop requesting unit 330 transmits a video transmission stop request so that the transmission of the high-resolution video of the first speaker is stopped.

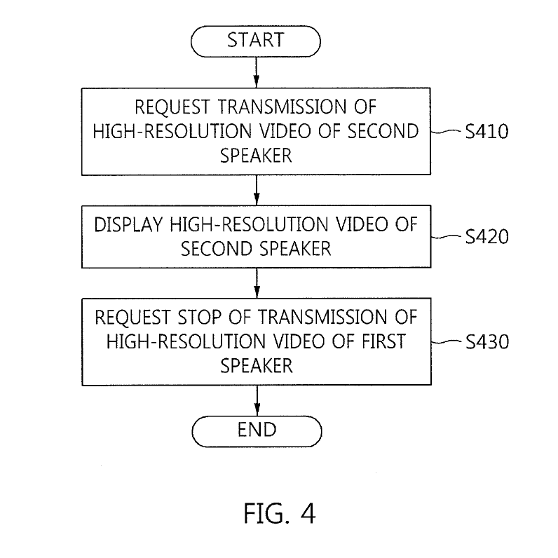

FIG. 4 is an operation flowchart showing a method of changing a main screen based on distributed telepresence according to an embodiment of the present invention.

Referring to FIG. 4, in the method of changing the main screen based on distributed telepresence according to the embodiment of the present invention, the transmission of a high-resolution video of a second speaker is requested from the client of the second speaker so that a main speaker is changed from a first speaker who is an existing main speaker to the second speaker who is different from the first speaker at step S410.

In this case, the main speaker may be determined in consideration of one or more of the results of analysis of audio signals of speakers and a user's selective input for low-resolution videos of the speakers.

Step S410 may be configured to determine whether the client of the second speaker is transmitting the high-resolution video of the second speaker, and, if it is determined that the client of the second speaker is not transmitting the high-resolution video of the second speaker, request the client of the second speaker to transmit the high-resolution video of the second speaker.

In this case, step S410 may be configured to request the client of the second speaker to insert an identifier for packet switching into the high-resolution video of the second speaker and transmit a resulting high-resolution video of the second speaker.

Further, step S410 may be configured to request the media processing device to generate the identifier-based switching entry of the second speaker and request the client of the second speaker to transmit the high-resolution video of the second speaker to the media processing device.

In this case, the media processing device may retransmit the high-resolution video of the second speaker to the user client according to the identifier-based switching entry.

Next, in the method of changing the main screen based on distributed telepresence according to the embodiment of the present invention, the high-resolution video of the first speaker is naturally replaced with the high-resolution video of the second speaker, and the high-resolution video of the second speaker is displayed to the user at step S420.

Then, in the method of changing the main screen based on distributed telepresence according to the embodiment of the present invention, the stop of the transmission of the high-resolution video of the first speaker is requested from the client of the first speaker so that the high-resolution video of the first speaker is stopped from being transmitted at step S430.

In this case, step S430 may be configured to determine whether the client of the first speaker is transmitting the high-resolution video of the first speaker to another user client different from the user client, and if it is determined that the client of the first speaker is not transmitting the high-resolution video of the first speaker to another user client different from the user client, request the client of the first speaker to stop transmitting the high-resolution video of the first speaker.

In this case, step S430 may be configured to request the media processing device to delete the identifier-based switching entry of the first speaker.

Here, the media processing device may receive a video of at least one client and may retransmit the video to one or more of at least one client different from the corresponding client and at least one media processing device different from the corresponding media processing device.

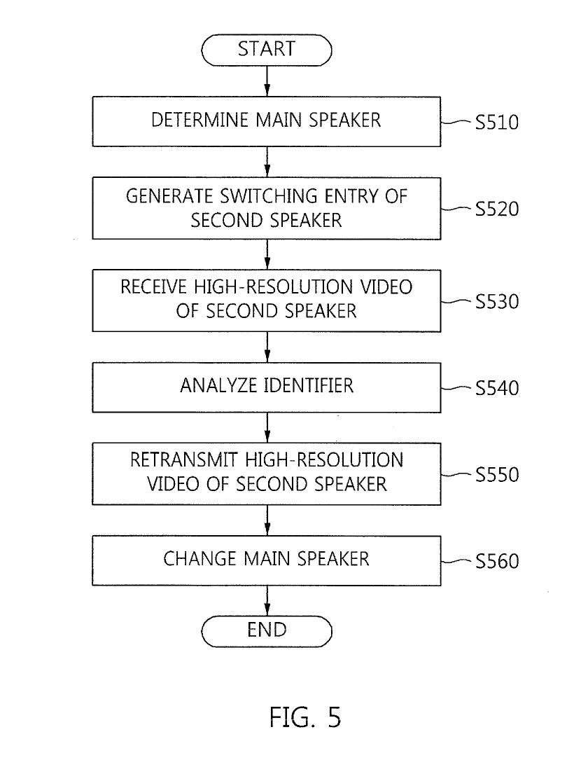

FIG. 5 is an overall operation flowchart showing the method of changing the main screen based on distributed telepresence according to the present invention.

Referring to FIG. 5, in the method of changing the main screen based on distributed telepresence according to the present invention, a main speaker is determined at step S510.

In this case, step S510 may be configured to determine the main speaker in consideration of one or more of the results of analysis of audio signals of speakers and a user's selective input for low-resolution videos of the speakers.

Further, in the method of changing the main screen based on distributed telepresence according to the present invention, the identifier-based switching entry of a second speaker is generated at step S520.

Then, in the method of changing the main screen based on distributed telepresence according to the present invention, a high-resolution video of the second speaker generated by inserting an identifier for packet switching into the high-resolution video is received at step S530.

Thereafter, in the method of changing the main screen based on distributed telepresence according to the present invention, the identifier of the second speaker inserted into the packet of the high-resolution video of the second speaker is analyzed at step S540.

Then, in the method of changing the main screen based on distributed telepresence according to the present invention, the high-resolution video of the second speaker is retransmitted at step S550.

In this case, step S550 may be configured to retransmit the high-resolution video of the second speaker to one of the corresponding user client and the media processing device of the user client according to the identifier-based switching entry of the second speaker using the identifier inserted into the packet of the high-resolution video of the second speaker.

Further, in the method of changing the main screen based on distributed telepresence according to the present invention, the existing high-resolution video of the first speaker being displayed is naturally replaced with the high-resolution video of the second speaker and the high-resolution video of the second speaker is displayed to the user, thus enabling the main speaker to be changed at step S560.

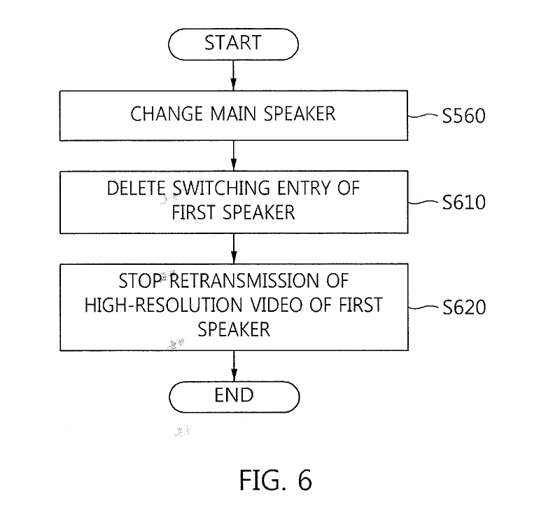

FIG. 6 is an operation flowchart showing the method of changing the main screen based on distributed telepresence according to the present invention from the standpoint of a media processing device.

Referring to FIG. 6, in the method of changing the main screen based on distributed telepresence according to the present invention, a main speaker is changed by naturally replacing the existing high-resolution video of the first speaker being played with a high-resolution video of a second speaker and displaying the high-resolution video of the second speaker to a user at step S560.

Then, in the method of changing the main screen based on distributed telepresence according to the present invention, the identifier-based switching entry of the first speaker is deleted at step S610.

Next, in the method of changing the main screen based on distributed telepresence according to the present invention, the retransmission of the high-resolution video of the first speaker is stopped at step S620.

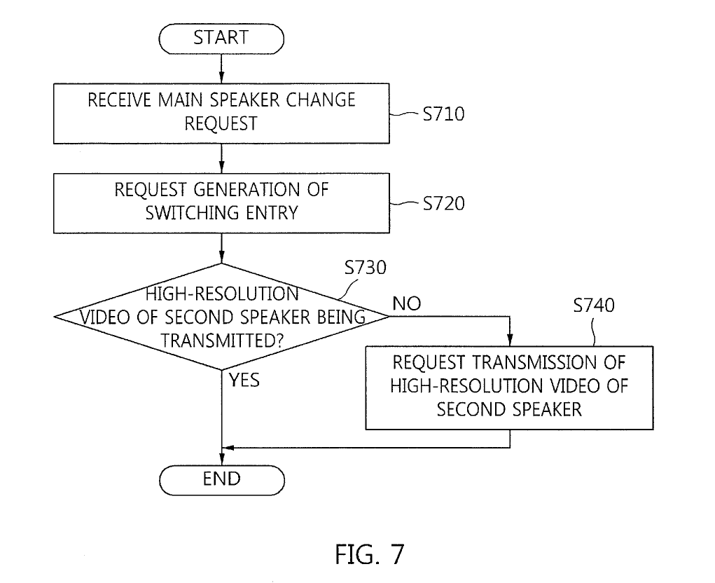

FIG. 7 is an operation flowchart showing the method of changing the main screen based on distributed telepresence according to the present invention from the standpoint of a control server.

Referring to FIG. 7, in the method of changing the main screen based on distributed telepresence according to the present invention, a main speaker change request for requesting the change of a main speaker from a first speaker who is an existing main speaker to a second speaker who is different from the first speaker is received at step S710.

Then, in the method of changing the main screen based on distributed telepresence according to the present invention, the generation of the identifier-based switching entry of the second speaker is requested at step S720.

Thereafter, in the method of changing the main screen based on distributed telepresence according to the present invention, it is determined whether the client of the second speaker is transmitting a high-resolution video of the second speaker at step S730.

In the method of changing the main screen based on distributed telepresence according to the present invention, if it is determined at step S730 that the client of the second speaker is not transmitting the high-resolution video of the second speaker, the transmission of the high-resolution video of the second speaker is requested from the client of the second speaker at step S740.

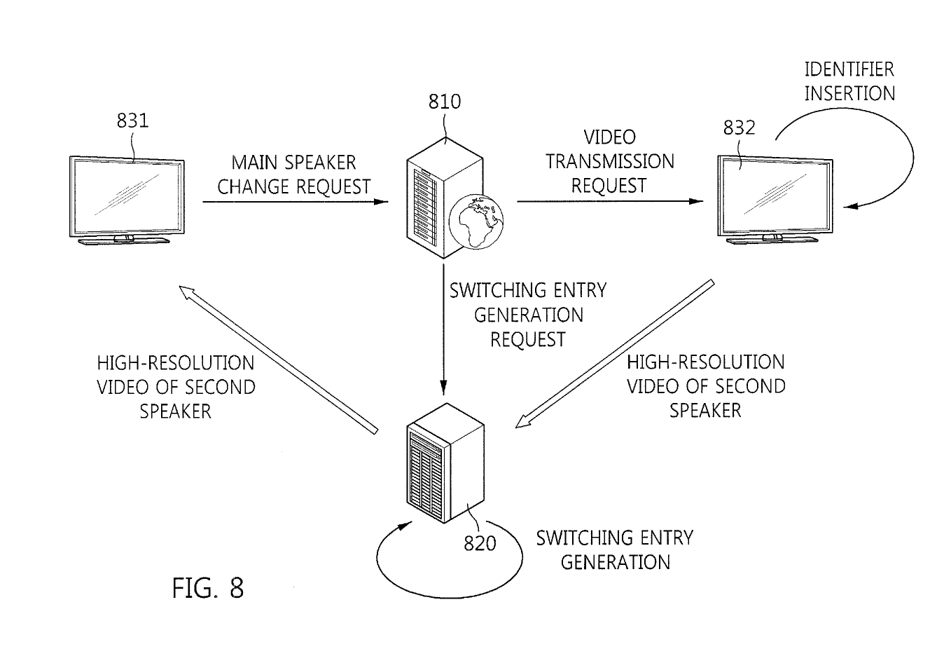

FIG. 8 is a diagram showing an embodiment of a system for changing a main screen based on distributed telepresence according to the present invention.

Referring to FIG. 8, the system for changing the main screen based on distributed telepresence according to the present invention includes a control server 810, a media processing device 820, a user client 831, and the client 832 of a second speaker.

The user client 831 may determine a main speaker in consideration of one or more of the results of analysis of audio signals of speakers and a user's selective input for low-resolution videos of the speakers, and request the control server 810 to change the main speaker.

The control server 810 requests the media processing device 820 to generate the identifier-based switching entry of the second speaker.

Further, the control server 810 requests the client 832 of the second speaker to transmit the high-resolution video of the second speaker to the media processing device 820.

The client 832 of the second speaker inserts an identifier for packet switching into the high-resolution video of the second speaker and transmits a resulting high-resolution video to the media processing device 820.

The media processing device 820 generates the identifier-based switching entry of the second speaker, receives the high-resolution video of the second speaker, analyzes the identifier included in the packet of the high-resolution video of the second speaker, and retransmits the high-resolution video of the second speaker to the user client 831 according to the switching entry.

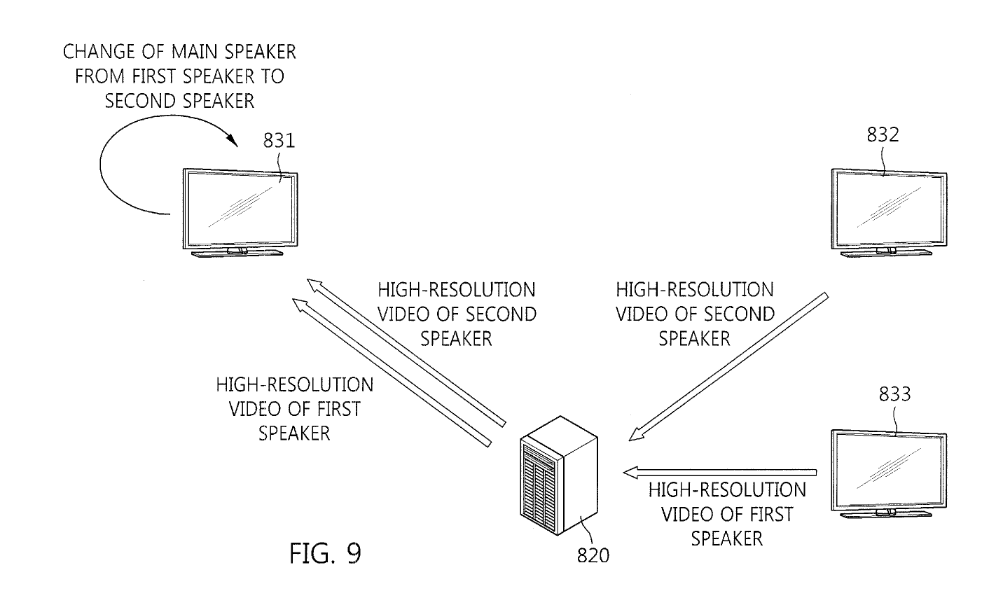

FIG. 9 is a diagram showing another embodiment of the system for changing the main screen based on distributed telepresence according to the present invention

Referring to FIG. 9, the system for changing the main screen based on distributed telepresence according to the present invention includes a media processing device 820, a user client 831, the client 832 of a second speaker, and the client 833 of a first speaker.

When an existing main speaker is the first speaker, the client 833 of the first speaker transmits a high-resolution video of the first speaker to the user client 831 through the media processing device 820.

When the user client 831 sets the second speaker to the main speaker, it requests a control server (not shown) to change the main speaker, and the client 832 of the second speaker transmits a high-resolution video of the second speaker to the user client 831.

That is, it can be seen that the media processing device 820 is currently transmitting the high-resolution videos of the existing main speaker and the new main speaker together to the user client 831.

In this case, the user client 831 may change the main speaker from the existing main speaker to the new main speaker by naturally replacing the high-resolution video of the first speaker with the high-resolution video of the second speaker and displaying the high-resolution video of the second speaker to the user.

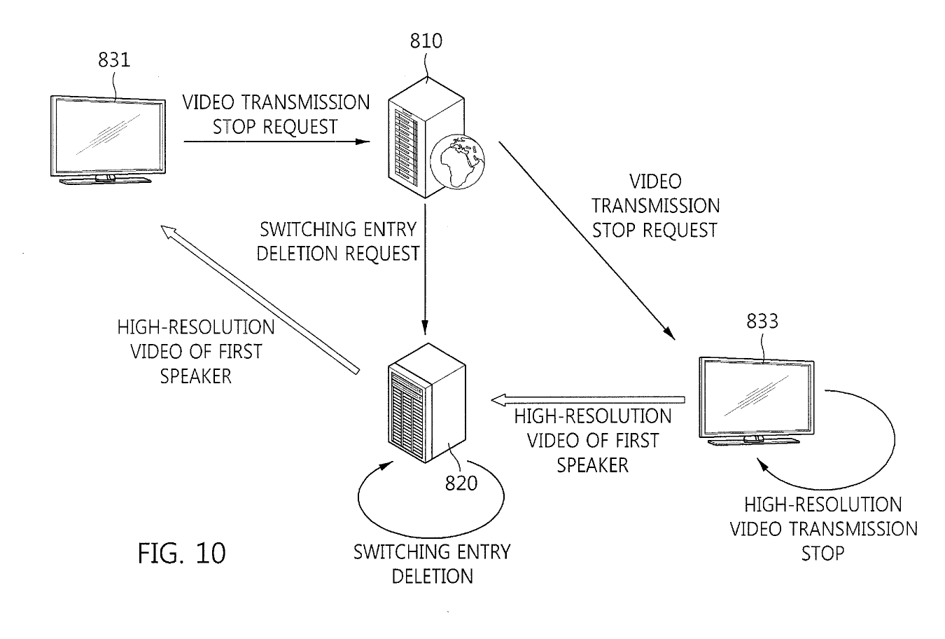

FIG. 10 is a diagram showing a further embodiment of a system for changing a main screen based on distributed telepresence according to the present invention.

Referring to FIG. 10, the system for changing the main screen based on distributed telepresence according to the present invention includes a control server 810, a media processing device 820, a user client 831, and the client 833 of a first speaker.

When an existing main speaker is the first speaker, the client 833 of the first speaker transmits a high-resolution video of the first speaker to the user client 831 through the media processing device 820.

The user client 831 changes a main speaker from the existing main speaker to a new main speaker by naturally replacing the high-resolution video of the first speaker with a high-resolution video of a second speaker and displaying the high-resolution video of the second speaker to the user, and then requests the stop of the transmission of the high-resolution video of the first speaker.

The control server 810 requests the media processing device 820 to delete the identifier-based switching entry of the first speaker.

Further, the control server 810 requests the client 833 of the first speaker to stop transmitting the high-resolution video of the first speaker.

The client 833 of the first speaker stops transmitting the high-resolution video of the first speaker.

The media processing device 820 deletes the identifier-based switching entry of the first speaker.

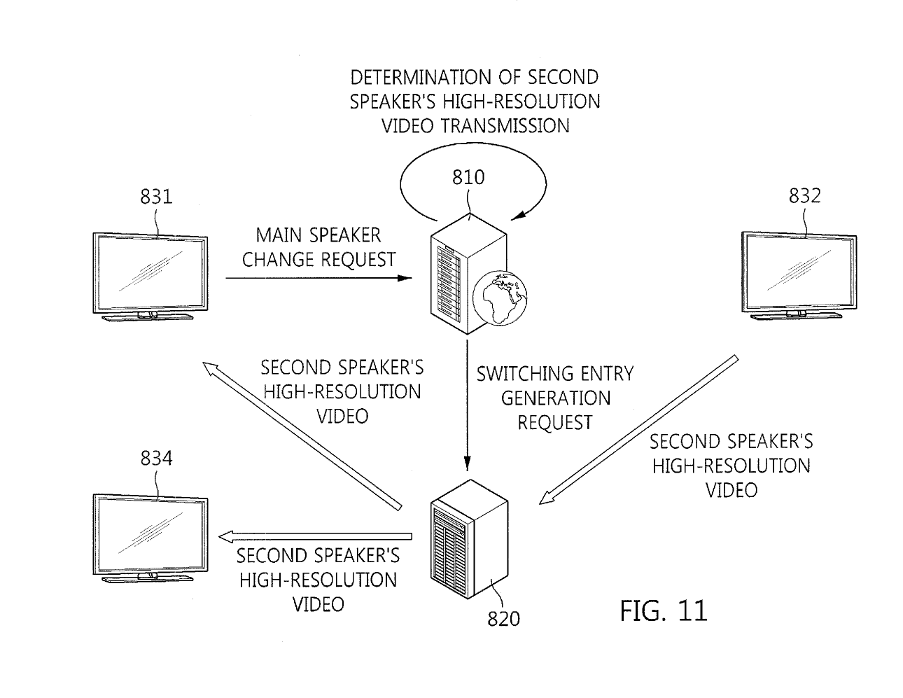

FIG. 11 is a diagram showing yet another embodiment of the system for changing the main screen based on distributed telepresence according to the present invention.

Referring to FIG. 11, the system for changing the main screen based on distributed telepresence according to the present invention includes a control server 810, a media processing device 820, user clients 831 to 834, and the client 832 of the second speaker.

The client 832 of the second speaker is currently transmitting a high-resolution video of the second speaker to the user client 834 through the media processing device 820.

The user client 831 may determine a main speaker in consideration of one or more of the results of analysis of audio signals of speakers and a user's selective input for low-resolution videos of the speakers, and request the control server 810 to change the main speaker.

The control server 810 requests the media processing device 820 to generate the identifier-based switching entry of the second speaker.

In this case, the control server 810 determines whether the client 832 of the second speaker is transmitting the high-resolution video of the second speaker, and if it is determined that the client of the second speaker is transmitting the high-resolution video of the second speaker, may not request the client of the second speaker to transmit the high-resolution video of the second speaker.

The media processing device 820 generates the identifier-based switching entry of the second speaker, and retransmits the existing high-resolution video of the second speaker being received to the user client 831 according to the switching entry.

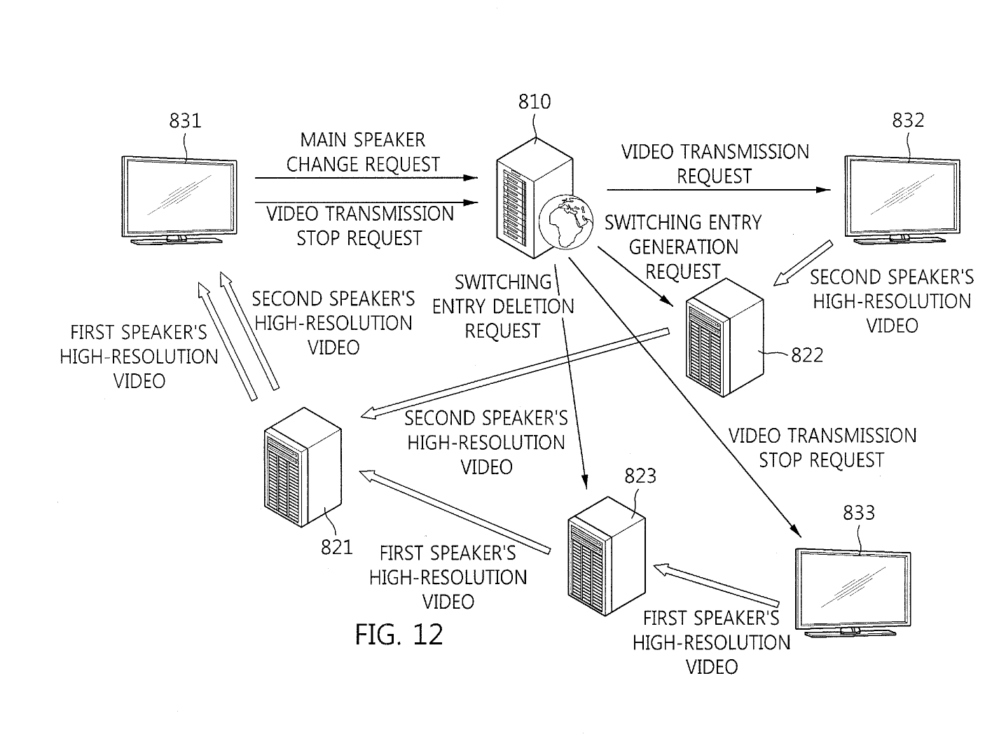

FIG. 12 is a diagram showing still another embodiment of the system for changing the main screen based on distributed telepresence according to the present invention.

Referring to FIG. 12, the system for changing the main screen based on distributed telepresence according to the present invention includes a control server 810, media processing devices 821 to 823, a user client 831, the client 832 of a second speaker, and the client 833 of a first speaker.

That is, it can be seen that the media processing devices 821 to 823 correspond to the respective clients 831 to 833.

Further, it can be seen that the media processing devices may directly retransmit a high-resolution video to the clients, but they may retransmit the high-resolution video to the clients through other media processing devices.

That is, as shown in FIGS. 8 to 12, it can be seen that a distributed telepresence-based media processing device according to the present invention corresponds to at least one client.

In accordance with the present invention, there can be provided a more natural telepresence system, which can naturally replace high-resolution videos of main speakers without being interrupted by displaying a high-resolution video of an existing main speaker on a screen until a high-resolution video of a new main speaker is received when a user client changes a main speaker.

Further, the present invention can provide a more efficient telepresence system, which can receive a high-resolution video of a new main speaker from a media processing device without repeatedly making a request to transmit the high-resolution video while the high-resolution video of the new main speaker is requested and is currently being received by another user client.

As described above, in the apparatus and method for changing a main screen based on distributed telepresence according to the present invention, the configurations and schemes in the above-described embodiments are not limitedly applied, and some or all of the above embodiments can be selectively combined and configured so that various modifications are possible.

What is claimed is:

1. A distributed telepresence-based control server, comprising:
a main speaker change request reception unit for receiving a main speaker change request for requesting a change of a main speaker from a first speaker who is an existing main speaker to a second speaker who is different from the first speaker;
a video transmission requesting unit for requesting a client of the second speaker to transmit a high-resolution video of the second speaker in response to the main speaker change request;
a video transmission stop request reception unit for receiving a video transmission stop request for requesting stop of transmission of a high-resolution video of the first speaker; and
a video transmission stop requesting unit for requesting a client of the first speaker to stop transmitting the high-resolution video of the first speaker in response to the video transmission stop request.

2. The distributed telepresence-based control server of claim 1, wherein the video transmission requesting unit is configured to determine whether the client of the second speaker is transmitting the high-resolution video of the second speaker, and if it is determined that the client of the second speaker is not transmitting the high-resolution video of the second speaker, request the client of the second speaker to transmit the high-resolution video of the second speaker.

3. The distributed telepresence-based control server of claim 2, wherein the video transmission requesting unit requests the client of the second speaker to insert an identifier for packet switching into the high-resolution video of the second speaker and transmit a resulting high-resolution video of the second speaker.

4. The distributed telepresence-based control server of claim 3, wherein the video transmission requesting unit requests a media processing device to generate an identifier-based switching entry of the second speaker, and requests the client of the second speaker to transmit the high-resolution video of the second speaker to the media processing device.

5. The distributed telepresence-based control server of claim 4, wherein the media processing device retransmits the high-resolution video of the second speaker to a user client according to the identifier-based switching entry.

6. The distributed telepresence-based control server of claim 5, wherein the video transmission stop requesting unit is configured to determine whether the client of the first speaker is transmitting the high-resolution video of the first speaker to another user client different from the user client, and if it is determined that the client of the first speaker is not transmitting the high-resolution video of the first speaker to another user client different from the user client, request the client of the first speaker to stop transmitting the high-resolution video of the first speaker.

7. The distributed telepresence-based control server of claim 6, wherein the video transmission stop requesting unit requests the media processing device to delete an identifier-based switching entry of the first speaker.

8. The distributed telepresence-based control server of claim 7, wherein the media processing device receives a video of at least one client, and retransmits the video to one or more of at least one client different from the client and at least one media processing device different from the media processing device.

9. A distributed telepresence-based user client, comprising:
a main speaker change requesting unit for transmitting a main speaker change request so that a main speaker is changed from a first speaker who is an existing main speaker to a second speaker who is different from the first speaker;
a video replacement unit for naturally replacing a high-resolution video of the first speaker with a high-resolution video of the second speaker received in response to the main speaker change request and displaying the high-resolution video of the second speaker to a user; and
a video transmission stop requesting unit for transmitting a video transmission stop request so that transmission of the high-resolution video of the first speaker is stopped.

10. The distributed telepresence-based user client of claim 9, wherein the main speaker is determined in consideration of one or more of results of analysis of audio signals of speakers and the user's selective input for low-resolution videos of the speakers.

11. A method of changing a main screen based on distributed telepresence, comprising:
requesting a client of a second speaker to transmit a high-resolution video of the second speaker so that a main speaker is changed from a first speaker who is an existing main speaker to the second speaker who is different from the first speaker;
naturally replacing a high-resolution video of the first speaker with the high-resolution video of the second speaker and displaying the high-resolution video of the second speaker to a user; and
requesting a client of the first speaker to stop transmitting the high-resolution video of the first speaker so that transmission of the high-resolution video of the first speaker is stopped.

12. The method of claim 11, wherein requesting the client of the second speaker is configured to determine whether the client of the second speaker is transmitting the high-resolution video of the second speaker, and if it is determined that the client of the second speaker is not transmitting the high-resolution video of the second speaker, request the client of the second speaker to transmit the high-resolution video of the second speaker.

13. The method of claim 12, wherein requesting the client of the second speaker is configured to request the client of the second speaker to insert an identifier for packet switching into the high-resolution video of the second speaker and transmit a resulting high-resolution video of the second speaker.

14. The method of claim 13, wherein requesting the client of the second speaker is configured to request a media processing device to generate an identifier-based switching entry of the second speaker, and request the client of the second speaker to transmit the high-resolution video of the second speaker to the media processing device.

15. The method of claim 14, wherein the media processing device retransmits the high-resolution video of the second speaker to a user client according to the identifier-based switching entry.

16. The method of claim 15, wherein requesting the client of the first speaker is configured to determine whether the client of the first speaker is transmitting the high-resolution video of the first speaker to another user client different from the user client, and if it is determined that the client of the first speaker is not transmitting the high-resolution video of the first speaker to another user client different from the user client, request the client of the first speaker to stop transmitting the high-resolution video of the first speaker.

17. The method of claim 16, wherein requesting the client of the first speaker is configured to request the media processing device to delete an identifier-based switching entry of the first speaker.

18. The method of claim 17, wherein the media processing device receives a video of at least one client, and retransmits the video to one or more of at least one client different from the client and at least one media processing device different from the media processing device.

19. The method of claim 18, wherein the main speaker is determined in consideration of one or more of results of analysis of audio signals of speakers and the user's selective input for low-resolution videos of the speakers.
